(19) United States
(12) Patent Application Publication
(10) Pub. No.: US 2025/0079861 A1
(43) Pub. Date: Mar. 6, 2025

(54) METHOD FOR ESTIMATING STATE OF BATTERIES BY USING A MULTI-LEVEL NEURAL NETWORK

(71) Applicant: NATIONAL TAIWAN UNIVERSITY OF SCIENCE AND TECHNOLOGY, Taipei (TW)

(72) Inventors: Chang-Hua LIN, Taipei (TW); Jhih-Han DAI, Taipei (TW); Yi-Xin LIN, Taipei (TW)

(73) Assignee: NATIONAL TAIWAN UNIVERSITY OF SCIENCE AND TECHNOLOGY, Taipei (TW)

(21) Appl. No.: 18/517,923

(22) Filed: Nov. 22, 2023

(30) Foreign Application Priority Data
Sep. 6, 2023 (TW) 112133914

(51) Int. Cl. H02J 7/00

(52) U.S. Cl. CPC H02J 7/0047; H02J 7/00032

(57) ABSTRACT

A method is to estimate the state of batteries by using a multi-level neural network formed with at least three neural networks. The method comprises steps of: extracting features from the charging and discharging data of a battery through a first-level neural network to form a first-stage output data, and inputting the first-stage output data into a second-level neural network; enhancing local features in the first-stage output data through the second-level neural network to form a second-stage output data; combining the first-stage output data with the second-stage output data to form a combination result to be input into a third-level neural network for data modeling, to generate a state estimation result of the battery. The present invention improves the accuracy of estimation for a flat zone in the charge/discharge curve of the battery, and quickly adjusts the multi-level neural network to achieve accurate estimation of different types of batteries.

### BACKGROUND OF THE INVENTION

### (1) Field of the Invention

The present invention relates to a method for estimating state of batteries, in particular to a method for estimating state of charge or health of batteries by using neural networks.

### (2) Description of the Prior Art

In the technology of applying neural network models to battery state estimation, it is an important thing to select the architectures and input parameters of the neural network models.

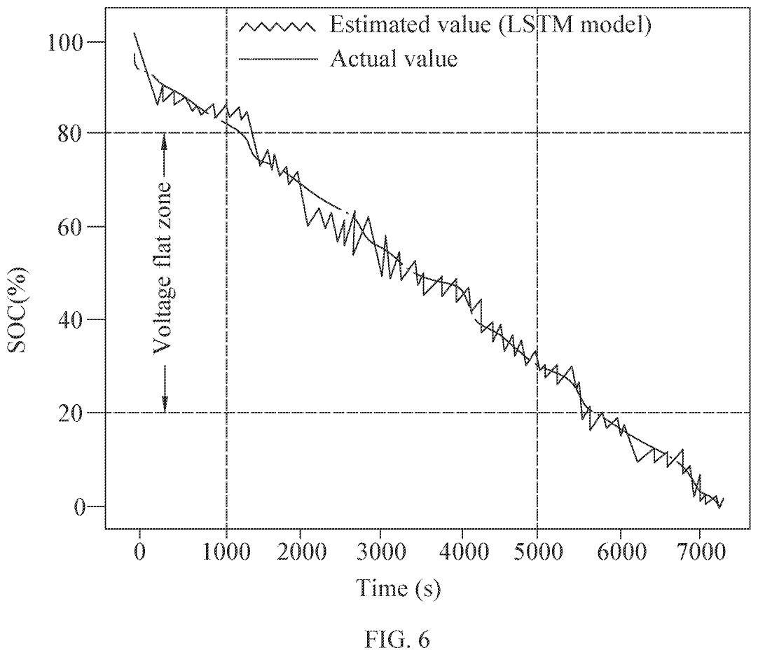

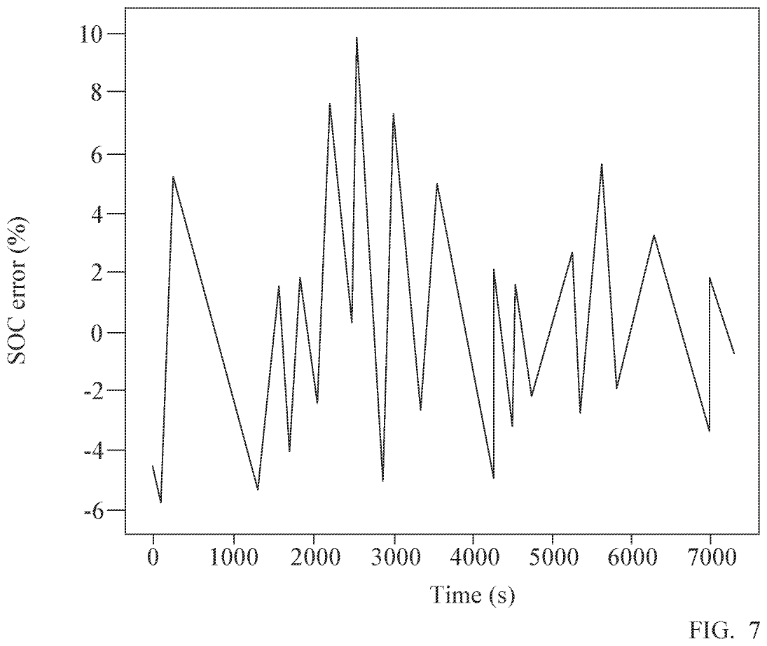

In the selection of architectures, comparing the architectures of learning neural network models such as Long Short Term Memory Networks (hereinafter referred to as LSTM) and Feedforward Neural Networks (hereinafter referred to as FNN), the results show that the error of estimating the state of charge (hereinafter referred to as SOC) of a general battery can reach less than 1% when different parameter combinations are applied according to the different characteristics of these neural network models; however, an extremely large error will occur in a stable and flat zone of the charge/discharge voltage curve (hereinafter also referred to as “voltage flat zone” or “voltage stable zone”) of lithium-iron batteries if the above-mentioned conventional neural network models are used to directly estimate the state of charge. For example, FIG. 6 and FIG. 7 show the estimation results using the conventional LSTM model. The estimation error in the voltage flat zone is up to 10%. In addition, if different parameter combinations are used for model training, different degrees of errors may be caused by differences between parameter combinations.

In the selection of input parameters, a neural network model usually uses voltage, current, temperature and related parameter combinations as its main input parameters. Therefore, the selection of input parameters for the neural network model must be adjusted based on the characteristics of its model architecture. For example, compared to Recurrent Neural Network (hereinafter referred to as RNN), FNN is less good at processing the output data related to time series. RNN is a model architecture commonly used in time-related models, such as a model of speech input. Therefore, when RNN is applied to battery state of charge estimation, it will be trained with continuous time parameters, such as voltage and current changes for several consecutive seconds, to improve the accuracy of the time-related output data of the RNN model.

Besides the aforementioned LSTM and FNN, the commonly known neural network models such as CNN-LSTM, Temporal Convolution Network (hereinafter referred to as TCN) and Transformer model also exist some disadvantages in estimating battery state.

The CNN-LSTM neural network architecture is a combination of a convolutional neural network (hereinafter referred to as CNN) and LSTM. Since the CNN part of this architecture performs a convolution operation on the present voltage and current, it can highlight the features of the present voltage and current. However, this architecture cannot effectively reduce the estimation error for the voltage flat zone of the lithium-iron battery.

The TCN model has high accuracy and can enhance the local features under constant temperature and charging current, so it can overcome the estimation error in the voltage flat zone of lithium-iron batteries. However, when testing the generalization ability of the TCN model, it is affected by continuous changes in ambient temperature, which increases the estimation error. In addition, the TCN model requires increasing the number of neural network layers to process the features of long-term sequence, thus significantly increasing the computing time.

Transformer model can estimate batteries of different brands and have better generalization ability than TCN. However, it has the same problem as using the LSTM model to estimate lithium-iron batteries. Transformer model also lacks local feature information and is difficult to apply to batteries of different types and characteristics.

In view of the shortcoming of the conventional neural network models, it is necessary to propose a novel model for performing a method that can improve the accuracy of battery state estimation in the voltage flat zone of the battery. Moreover, the proposed method also needs to consider the generalization ability of the proposed model so that the proposed model can be quickly applied to different types of batteries and achieve accurate state estimation.

### SUMMARY OF THE INVENTION

One object of the present invention is to provide a method for estimating battery state using a multi-level neural network, which can improve the accuracy of state estimation in the flat zone of the charge/discharge curve of the battery.

Another object of the present invention is to provide a method for estimating battery state using a multi-level neural network, which can reduce training time and data collection time, so that the multi-level neural network can be quickly applied to different types of batteries and achieve accurate state estimation.

In order to achieve the aforementioned object, the present invention provides a method for estimating state of batteries comprising steps of: providing a first-level neural network, a second-level neural network and a third-level neural network to form a multi-level neural network; extracting features from a charging and discharging data of a battery to be estimated through the first-level neural network to form a first-stage output data, and transferring the first-stage output data to the second-level neural network; enhancing local features in the first-stage output data through the second-level neural network to form a second-stage output data; combining the first-stage output data with the second-stage output data to form a combination result; and inputting the combination result into a third-level neural network for data modeling, to generate a state estimation result of the battery to be estimated.

In an embodiment, the charging and discharging data is a time series data including the features selecting from a group consisting of voltage, current, temperature and their combination.

In an embodiment, the step of forming the combination result comprises: applying a positional encoding to the first-stage output data for combining with the second-stage output data.

In an embodiment, the first-level neural network includes a denoising autoencoder model, the second-level neural network includes a temporal convolution model, and the third-level neural network includes a attention model.

In an embodiment, forming the second-stage output data comprises steps of: providing a dropout layer in the temporal convolution model; performing a convolution operation to the first-stage output data through the temporal convolution model; and combining feature data output from the dropout layer with the features in the first-stage output data that have not yet entered the temporal convolution model.

In an embodiment, the method further comprises a training process, wherein the training process comprises step of: providing Gaussian noise for the first-level neural network.

In an embodiment, the training process comprises steps of: providing a first training dataset collected from a first battery to train the multi-level neural network, so as to make the multi-level neural network suitable for estimating the state of the first battery; provide a second training dataset collected from a second battery, and the data volume of the second training dataset is less than that of the first training dataset, for example, the data volume of the second training dataset provided for the training process is reduced by 30% of that of the first training dataset; wherein, the second battery is the battery to be estimated, and the second battery has at least one of type, brand and capacity different from the first battery; using the second training dataset to train the multi-level neural network that has been previously trained with the first training dataset; and employing the multi-level neural network trained by the second training dataset to estimate the state of the battery to be estimated.

In an embodiment, the ranges of electric current of the first training dataset and the second training dataset are consistent or inconsistent, and the method further comprises step of: providing an input data collected from the second battery for an estimation task thereof to be input the multi-level neural network, wherein the input data includes a range of electric current consistent with that of the second training dataset.

In an embodiment, the method further comprises a step of: performing an estimation within a voltage flat zone of the battery to be estimated.

The multi-level neural network model of the present invention can improve the state estimation in the voltage stable or flat zone of the battery through the processes such as noise removal and local feature enhancement, especially in the voltage flat zone of lithium-based batteries, the estimation accuracy is higher than that of the prior art. Moreover, the transfer learning method is used to apply a model pre-trained in one task to another related task to reduce training time and the need for data collection. In particular, when the model trained in the capacity estimation task of lithium-based batteries is applied to other batteries with different types, brands or capacities, there is no need to provide a large amount of new data for retraining, so it can save time and resources, make quickly estimate, improve estimation accuracy and performance for new tasks.

### BRIEF DESCRIPTION OF THE DRA WINGS

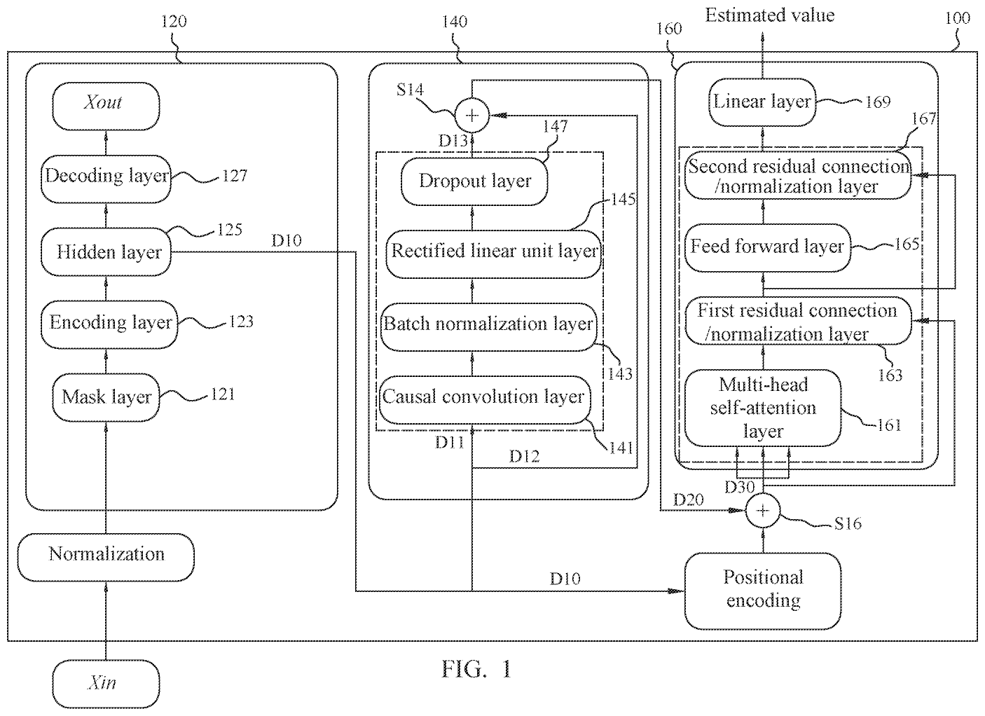

FIG. 1 is a schematic diagram of a multi-level neural network according to an embodiment of the present invention.

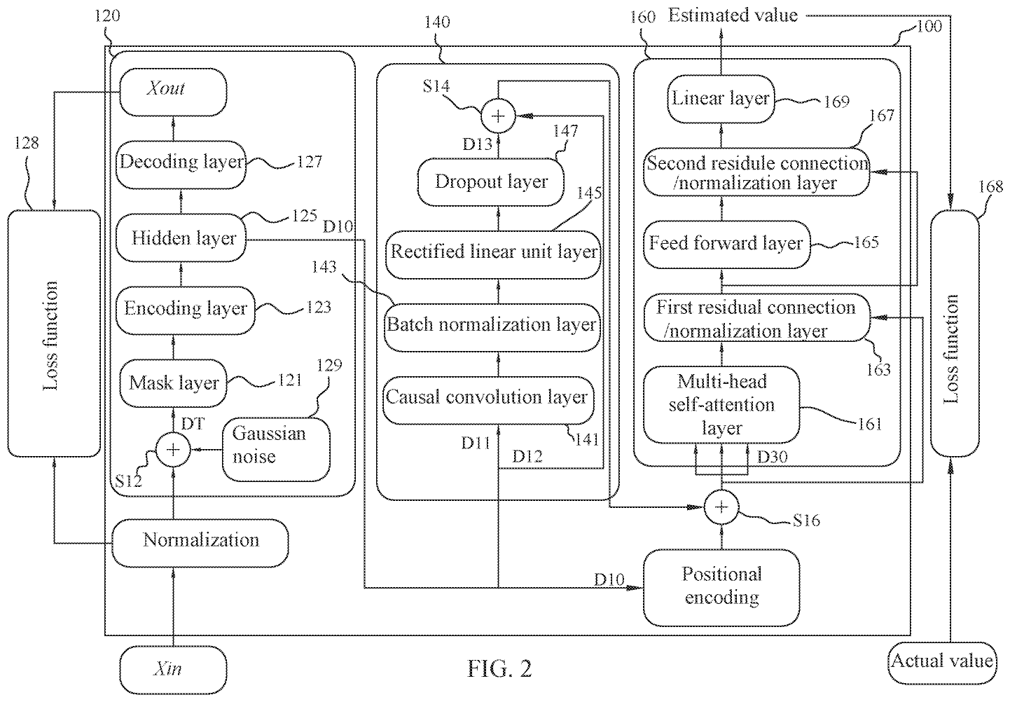

FIG. 2 is a schematic diagram showing a training method of a multi-level neural network according to an embodiment of the present invention.

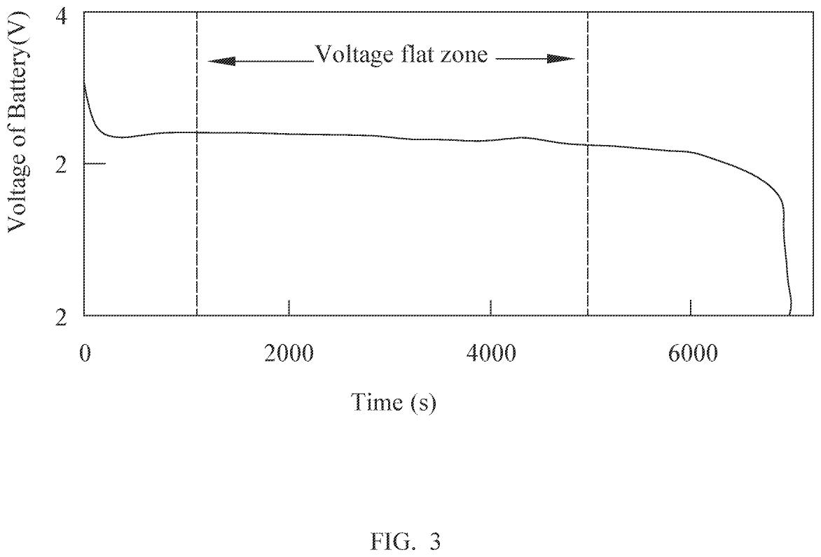

FIG. 3 is a schematic diagram of the voltage stable or flat zone according to an embodiment of the present invention.

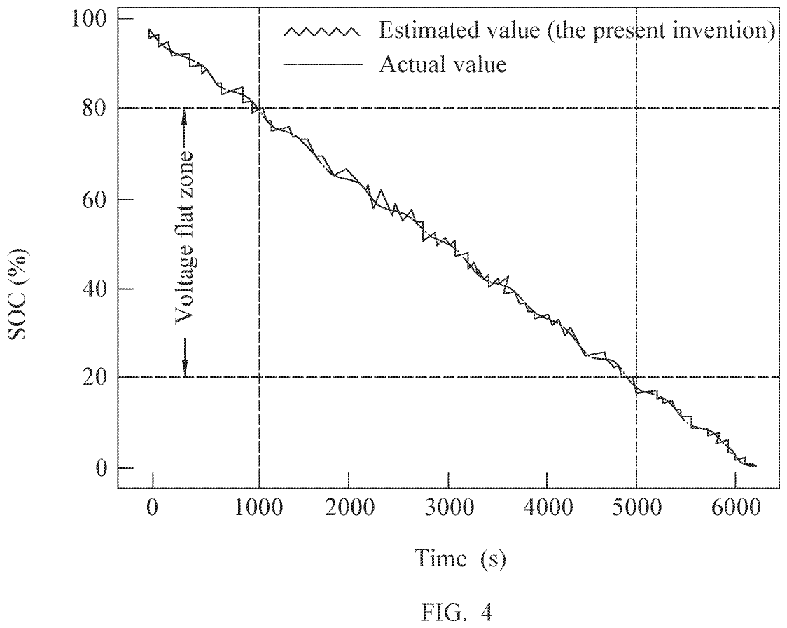

FIG. 4 is a schematic diagram showing the estimation results of a lithium-iron battery under dynamic load within the voltage flat zone estimated with a multi-level neural network according to one embodiment of the present invention.

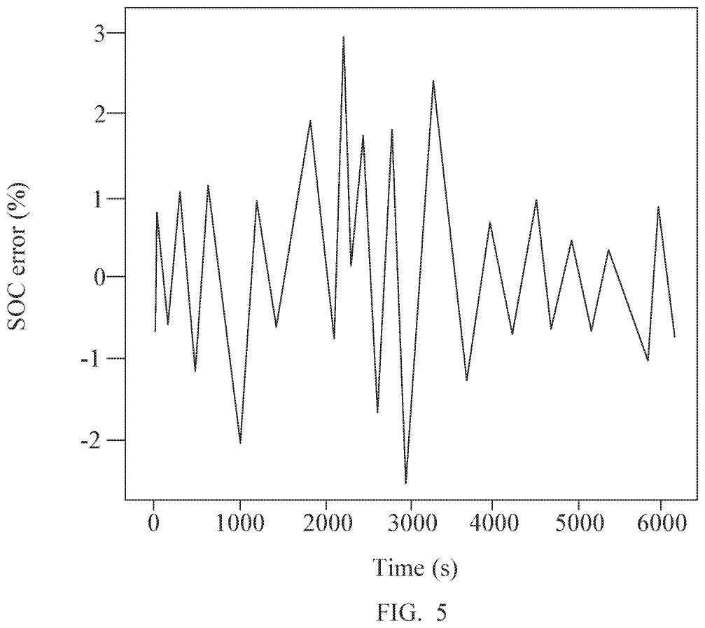

FIG. 5 is a schematic diagram showing the estimation error of a lithium-iron battery under dynamic load within the voltage flat zone estimated with a multi-level neural network according to an embodiment of the present invention.

FIG. 6 is a schematic diagram showing the estimation results of a lithium-iron battery under dynamic load within the voltage flat zone estimated with a conventional neural network model.

FIG. 7 is a schematic diagram showing the estimation error of a lithium-iron battery under dynamic load within the voltage flat zone estimated with a conventional neural network model.

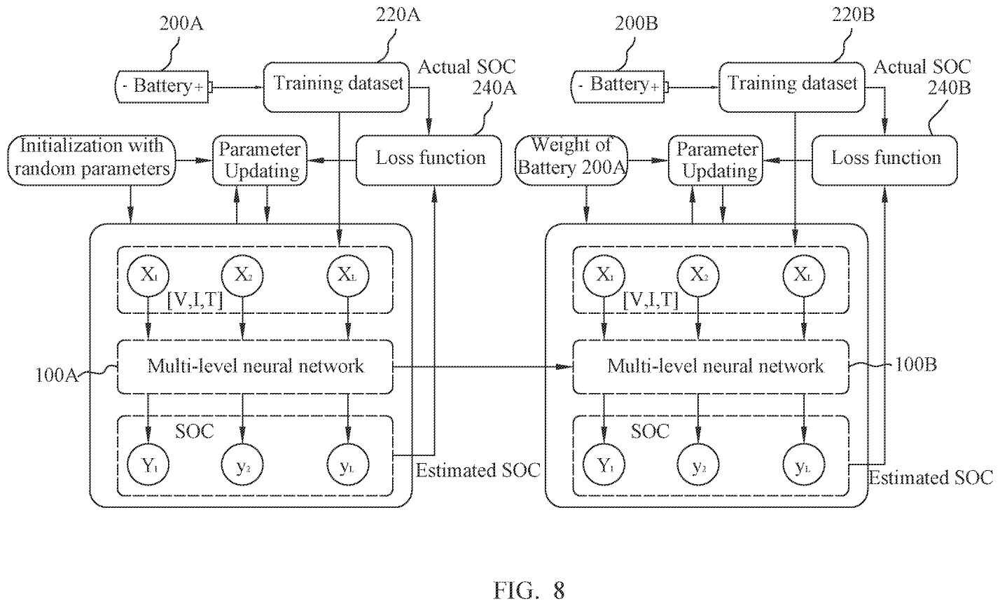

FIG. 8 is a schematic diagram of transfer learning according to an embodiment of the present invention.

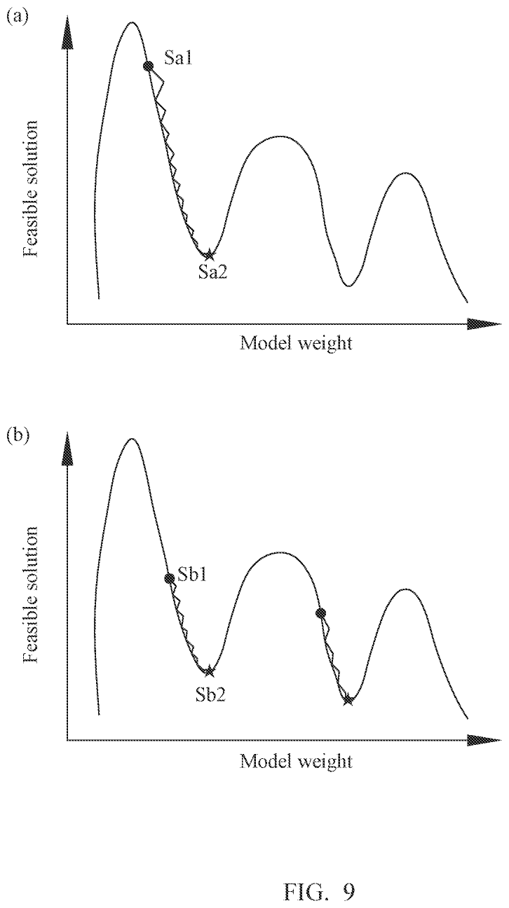

FIG. 9 is a schematic diagram showing a comparison of the required time for the estimation tasks performed by the conventional training method (a) and the present transfer learning method (b).

### DESCRIPTION OF THE PREFERRED EMBODIMENTS

Regarding technical contents, features and effects disclosed above and other technical contents, features and effects of the present invention will be clearly presented and manifested in the following detailed description of the exemplary preferred embodiments with reference to the accompanying drawings which form a part hereof.

### Embodiment 1: Multi-Level Neural Network

FIG. 1 is a multi-level neural network 100 according to an embodiment of the present invention, which is suitable for estimating the state of a battery. The multi-level neural network 100 includes a first-level neural network, a second-level neural network and a third-level neural network. The first-level neural network includes a denoising model 120, such as a de-noising auto-encoder (DAE) model; the second-level neural network includes a temporal convolution model 140, such as a causal convolution neural network (causal CNN) model; the third-level neural network includes an attention model 160, such as Transformer model.

When performing an estimation task, the denoising model 120 receives an input data Xin first and then normalizes the battery feature values in the input data Xin, for example, scales the battery feature values between [0,1] for normalization to construct a time series data, so that a dynamic change data of one or more features over a period of time is extracted from the input data Xin to be formed as “global features”. The input data Xin collected from the battery is originally a raw charging and discharging data containing noise; and the one or more features to be extracted can be selected from battery voltage, current or/and temperature in the time series data. Next, the feature values at different time points for the one or more features are organized into a first feature vector D10, which is employed as a first-stage output data. For example, three kinds of features such as battery voltage, current and temperature to be extracted from the input data Xin are collected every one second, and collected continuously for 200 seconds, then the global features of the input data Xin include 200 seconds×3 features=600 feature values. These 600 feature values can be represented by matrices or vectors, which are input into the denoising model 120 for dimensionality reduction. In one embodiment, if the output is set to 128 dimensions, the denoising model 120 will map these 600 feature values to 128 dimensions, so that the relationship between the 128-dimensional feature values maintains the relationship between the original 600 feature values to form the first feature vector D10.

Next, the temporal convolution model 140 is used to enhance the “local features” of the first feature vector D10 to generate a second feature vector D20, which is the second-stage output data. The local features are the more subtle feature changes found out from the global features. For example, assuming that the global features include 300 feature values, the local features are obtained by performing a convolution operation on each plurality of feature values included in these 300 feature values to re-find the relationship between the plurality of feature values, but the total number of feature values has not changed, it remains at 300. The second feature vector D20 is then combined with the first feature vector D10 that has been positional encoded as shown at step S16. The process of combination (step S16) may involve arithmetic or/and logical addition operations; then, the attention model 160 performs a global dependency modeling on the time series data to obtain a modeling result according to the combined result D30. Finally, the modeling result is employed to estimate the state of charge (SOC) or state of health (SOH) of the battery to generate an estimated value.

The configuration and operation of the denoising model 120, the temporal convolution model 140 and the attention model 160 are described in more detail below.

Before the denoising model 120 is actually used for estimation, it will first undergo training on the denoising ability. The training process is shown in FIG. 2 for the Embodiment 2 below. During estimation, the denoising model 120 that has passed the training of the denoising capability performs operations such as encoding and feature extraction on the received original or raw input data Xin through the mask layer 121, the encoding layer 123, and the hidden layer 125, so as to obtain the first feature vector D10. The first feature vector D10 is then transferred to the temporal convolution model 140 by the hidden layer 125 or decoded via the decoder 127.

The temporal convolution model 140 includes one or more basic unit blocks, and the number of the basic unit blocks depends on the needs of a target task. To simplify the explanation, FIG. 1 shows only one basic unit block as the dotted box in the temporal convolution model 140. Each of the basic unit blocks of the temporal convolution model 140 includes a causal convolution layer 141, a batch normalization layer 143, and a rectified linear unit layer 145 and a dropout layer 147.

It is worth noting that during estimation, a feature D11 in the first feature vector D10 that has entered the temporal convolution model 140 undergoes a convolution operation to form a feature data D13 that is output from the dropout layer 14. The feature data D13 is then combined with a feature D12 in the first feature vector D10 that has not entered the temporal convolution model 140 to form the second feature vector D20 (step S14). The process of combining (step S14) may involve arithmetic or/and logical addition operations. In addition, the second feature vector D20 is not directly input into the attention model 160 for data modeling. Before data modeling, the multi-level neural network 100 will first perform a positional encoding on the global features of the first feature vector D10, then combine the positional-encoded global features with the second feature vector D20 enhanced the local features to form a combined result D30. Finally, the combined result D30 is input to the attention model 160 for global dependency modeling of the input data Xin.

The attention model 160 includes one or more basic unit blocks and a linear layer (also known as “full-connected layer”) 169. The number of the basic unit blocks depends on the needs of the target task. To simplify the explanation, FIG. 1 shows only one basic unit block of the attention model 160. Each of the basic unit blocks of the attention model 160 includes a multi-head attention layer 161 with a self-attention mechanism, a first residual connection/normalization layer 163 (also known as “first add & norm layer”), a feed forward layer 165, a second residual connection/normalization layer 167 (also known as “second add & norm layer”).

### Embodiment 2: Training and Estimation Process of Multi-Level Neural Network

As shown in FIG. 2, in the process of training the multi-level neural network 100, the denoising model 120 first adds Gaussian noise 129 to a noise-free input data Xin (step S12) to form a set of time series data DT, and then performs the operations such as encoding, feature extraction, and decoding on the time series data DT. The step S12 may involve arithmetic or/and logical addition operations. Adding Gaussian noise can increase the denoising ability of the hidden layer 125 of the denoising model 120. After the hidden layer 125 performs feature extraction on the time series data DT, the first feature vector D10 will be obtained. Before the first feature vector D10 is decoded by the decoding layer 127, it will be provided to the temporal convolution model 140 for the next stage of processing. The decoding layer 127 provides the output data Xout obtained by decoding the first feature vector D10 for the loss function 128, to calculate a reconstruction error of the denoising model 120.

The temporal convolution model 140 performs a convolution operation on the first feature vector D10 output from the denoising model 120, thereby enhancing the local features in the first feature vector D10 to generate a second feature vector D20. The combination result of the first feature vector D10 and the second feature vector D20 are provided for the attention model 160 to generate a required time series for the calculating of estimated value. The function of the attention model 160 is to perform data modeling on the global features of the required time series to calculate the estimated value, and to use the estimated value or estimation results through the loss function 168 to calculate an estimation error of the multi-level neural network 100 during the training process.

FIG. 2 shows the method of loss calculation in the training process. Firstly, the denoising model 120 is employed to reconstruct the first feature vector D10 obtained after trained by adding the Gaussian noise 129 to form a reconstruction result, and then compare the reconstruction result with the original or raw input data Xin used for training to obtained the reconstruction error. The mean squared error (MSE) can be employed as the loss function 128 to calculate the reconstruction error of the denoising model 120. Secondly, the mean squared error (MSE) is also used as the loss function 168 to calculate an estimation error according to the estimated value output from the multi-stage neural network 100 as well as the actual value. Finally, the reconstruction error and the estimation error are added together to obtain an overall loss. During the training process, the backpropagation algorithm (BP) may be used to adjust the parameters such as weights of the multi-level neural network 100, so that the overall loss becomes smaller and smaller until the overall loss reaching a predetermined convergence standard, or the number of training times reaching a predetermined upper limit. The smaller the overall loss, it also means that the multi-level neural network 100 has a stronger ability to perform a data modeling on the features of the time series data.

In one embodiment, the multi-level neural network 100 only uses three features including battery voltage, current and temperature for training and estimation. Compared with using the combination of more features, this embodiment using the combination of the three features is simpler and easier to apply in practice.

The training and estimation process of multi-level neural networks is explained in more detail below.

In practical applications, the original or raw input data Xin may contain sensor noise, which may affect the accuracy of the model. Therefore, adding Gaussian noise 129 to the training helps to improve the robustness of the model to handle noise better. The denoising model 120 can learn how to extract useful features from the time series data DT added with Gaussian noise 129 in the training. The output data Xout generated by the denoising model 120 after receiving the time series data DT will be different from the output data Xout generated by the denoising model 120 after directly receiving the original input data Xin. The reason is that the adding Gaussian noise 129 will change the original input data Xin, so that the output data Xout will also be different.

Therefore, it is necessary to employ a suitable objective function as the loss function to calculate the loss, for example, employing the mean square error (MSE) or the root mean squared error (RMSE) as loss function 128 or/and 168 in FIG. 2. Both loss functions 128 and 168 can be the same or different functions, as long as they can measure the difference between the output data Xout of the denoising model 120 and a predetermined target output. During the training process, the target output of the denoising model 120 is set to the original input data Xin without adding Gaussian noise 129. The denoising model 120 will reconstruct the original input data Xin without adding Gaussian noise 129 using the time series data DT added with Gaussian noise 129, and minimize the MSE. For the purpose of minimizing MSE, the BP algorithm is employed to train the denoising model 120, so that the weights and errors of the model are adjusted through backpropagation to minimize MSE. The parameters of the denoising model 120 need to be continuously adjusted with the progress of training until the reconstruction error reaches a minimum value.

In the next stage, the temporal convolution model 140 is employed to perform a convolution operation on the time series contained in the first feature vector D10, thereby enhancing the local features of the first feature vector D10, which is characterized by not allowing future information influences current estimates. In order to effectively process time series, the temporal convolution model 140 can introduce a padding strategy to keep the features generated by the convolution operation relevant to the corresponding time points on the time axis, thereby achieving the estimation of the time series. Moreover, the feature data D13 output by the dropout layer 147 is combined with the feature D12 that has not yet entered the temporal convolution model 140 (step S14) to increase the estimation accuracy of the temporal convolution model 140.

Finally, the convolution result of the temporal convolution model 140, that is the “second feature vector D20”), is combined with the original input feature, that is the “first feature vector D10” (step S16). The first feature vector D10 needs to be positionally encoded to combine with the second feature vector D20 (step S16), that is to make the features with corresponding time points contained in second feature vector D20 match that of the first feature vector D10. The combining result D30 is transferred to the attention model 160 to establish the global features of the time series data DT.

In one embodiment, only the encoder part of the Transformer model is employed as the attention model 160, which is a sequence-to-sequence model based on the attention mechanism to establish the global features of a time series. The encoder part of the Transformer model includes multiple basic unit blocks. Each of the basic unit blocks of the Transformer model includes multiple attention mechanisms, residual connections and fully connected layers to capture dependencies between different segments of the time series. In this way, the attention model 160 can establish the relationship between different segments of the time series without considering the chronological order, making it easier for the attention model 160 to find important features of the time series.

For the process of a time series, the attention model 160 needs to convert the time series into a two-dimensional matrix, wherein the “column” of the two-dimensional matrix represents Time Step and the “row” represents dimensions of local feature vectors at each Time Step. Specifically, in each basic unit block of the attention model 160, a self-attention mechanism is employed to capture the dependencies between different time steps in the time series, and a fully connected layer 169 is employed to extract features after the attention mechanism. In addition, the attention mechanism and the feature vector of the fully connected layer will perform residual connection and layer normalization operations to avoid gradient disappearance. In the training of the attention model 160, the output of one basic unit block is for the input of the next basic unit block. In this way, the attention model 160 can gradually establish the relationship between different time steps in the time series, thereby capturing the features of the time series. Finally, the output of the attention model 160 is employed as the estimation result, such as an estimated SOC value.

### Embodiment 3: Estimating Battery State Using Multi-Level Neural Network

The multi-level neural network 100 of the above embodiment is further applied to estimate the SOC of the lithium iron battery under dynamic load. FIG. 3 shows that the voltage changes of lithium iron batteries are relatively stable in the time interval of about 1000 to 5000 seconds. This time interval is called the “voltage flat zone” or “voltage stable zone”. Comparing FIG. 3 and FIG. 4, it can be observed that when the lithium iron battery is in the voltage flat zone, its SOC is 80% to 20%. FIG. 4 shows that the estimated SOC value obtained by the multi-level neural network 100 of the present invention within the voltage flat zone is generally close to the actual value. FIG. 5 shows that the maximum error is 3%, and the calculated root mean square error (RMSE) is only 0.635%, which meets the requirements for general commercial use that the estimation error should be below 5%.

FIG. 6 is the result of using the conventional LSTM model to estimate the SOC of the lithium iron battery. Compared with FIG. 4, FIG. 6 shows that the estimated SOC value obtained by the LSTM model within the voltage flat zone deviates significantly from the actual value. FIG. 7 shows that the maximum error in estimation by the LSTM model reaches 10%, and the calculated RMSE is 2.398%. Compared with the conventional LSTM model, the multi-level neural network 100 of the present invention has obvious advantages in estimation accuracy.

### Embodiment 4: Transfer Learning

FIG. 8 is a schematic diagram of transfer learning. This embodiment uses a fine-tuning strategy to transfer the features between two batteries of different types, different brands, different capacities or characteristics. It only needs to add a small amount of data of other lithium batteries to the multi-level neural network trained in the previous capacity estimation task for the learning of the multi-level neural network, but not require collecting a large amount of new data to retrain the multi-level neural networks. Not only can it significantly save time and resources, but it can also improve the accuracy and performance of estimating the states of other lithium batteries.

As shown in FIG. 8, in the process of a multi-level neural network 100A performing the capacity estimation task of a battery 200A, the multi-level neural network 100A first uses random parameters for initialization; and a training dataset 220A collected from the battery 200A is used for training the multi-level neural network 100A. The training dataset 220A contains the time series data [x1, x2 . . . xL] including the features such as voltage V, current I, temperature T of the battery 200A. After inputting the time series data [x1, x2 . . . xL] into the multi-level neural network 100A, the generated feature vector [y1, y2 . . . yL] can be used to obtain an estimated SOC by operations such as dimension reduction, making the estimated SOC closest to the actual SOC. The estimated SOC and actual SOC are passed through a loss function 240A, and parameters are updated based on the calculation results of the loss function 240A, thereby training the multi-level neural network 100A suitable for estimating the state of the battery 200A.

Then, the following transfer learning method is employed to apply the multi-level neural network 100A that has been trained in the previous capacity estimation task of battery 200A to the capacity estimation task of a target battery 200B. It will save a lot of time and only require a small amount of data collected from the target battery 200B.

The steps of transfer learning are as follows:
(a) Loading the pre-trained model: The pre-trained multi-level neural network 100A and its weight parameters for the capacity estimation task of the battery 200A are loaded in the capacity estimation task of the battery 200B.
(b) Unfreeze the top basic unit blocks: The top or last few basic unit blocks of the multi-level neural network 100A are unfrozen so that they can participate in training; but the bottom or preceding basic unit blocks of the multi-level neural network 100A remains unchanged.
(c) Add a new top basic unit block: One or more new basic unit blocks are added to the multi-level neural network 100A for the capacity estimation task of the battery 200B. The new basic unit blocks will be trained to adapt to the new capacity estimation task of the battery 200B.
(d) Training the model: Use the training dataset 220B collected from the battery 200B and the feature vector output by the multi-level neural network 100A for inputting to train the newly added top basic unit block. At the same time, the top basic unit blocks of the multi-level neural network 100A will also be fine-tuned to form a new multi-level neural network 100B. For example, input the weights of different types, capacities, and brands batteries into a multi-level neural network, and fine-tune the weights through the optimizer. If the loss is greater than a predetermined value, continue training until the loss is less than the predetermined value.
(e) Evaluate the model: After the training is finished, a test dataset can be employed to evaluate the accuracy and performance of the fine-tuned multi-level neural network 100B. If the evaluation results are not satisfactory, go back to step (c) and try to adjust the newly added top layer or adjust parameters such as learning rate.

It is worth emphasizing that the amount of data required for the training dataset 220B of the battery 200B can be less than the amount of data required for the training dataset 220A of the battery 200A, thereby reducing the data collection time and training time of the multi-level neural network 100B. For example, if the multi-level neural network 100A needs 10 pieces of dynamic load data for training to estimate the dynamic load curve of a unknown battery such as the battery 200B, the multi-level neural network 100B formed through transfer learning may only need 3 pieces of dynamic load data of the battery 200B to achieve the same estimation effect. In an embodiment, the data volume of the training dataset 220B can be reduced by 30% of the data volume of the training dataset 220A.

In this embodiment, the ranges of electric current may be consistent or inconsistent for the data of two training datasets 220A and 220B, so that the adaptable ranges of the electric current for the multi-level neural network 100B can be the same as or different from that for the multi-level neural network 100A. However, it should be noted that for the same multi-level neural network, the ranges of the electric current must be consistent for the training data and the input data of the estimation task. For example, if the ranges of the electric current is-5A to 10A for the training dataset 220B of the multi-level neural network 100B, then the input data of the estimation task also needs to fall within this range for the multi-level neural network 100B.

FIG. 9 is a schematic diagram showing a comparison of the required time for the estimation task performed by the conventional training method (a) and the present transfer learning method (b). It can be observed that since the initial weight Sa1 of the conventional training method is a random parameter, in the process of finding the optimal solution Sa2 of the loss function, the number of adjusting the model weight is large, so it takes a long time. However, after performing transfer learning on the pre-trained model, the adjusting is started from the initial weight Sb1 obtained from previous training, so that the number of adjusting the model weight can be reduced and the model weight can approach the optimal solution Sb2 more quickly. Obviously, the present invention introduces a transfer learning method and applies the model that has been pre-trained in the capacity estimation task of lithium battery to other types of batteries. This saves time and resources in retraining and collecting large amounts of new data, while improving estimation accuracy and performance on new tasks.

To sum up, the method of the present invention includes the basic steps of: forming a multi-level neural network by combining at least three neural networks; and performing a convolution operation by passing a first-stage output data of a first-level neural network through a second-level neural network for enhancing local features of the first-stage output data to generate a second-stage output data; then combining the second-stage output data with the position-encoded first-stage output data, and providing the combined result to a third-level neural network to perform a global dependency modeling; finally, using the modeling results to estimate the battery state. The multi-level neural network can improve the estimation accuracy in the voltage flat zone of batteries through processes such as de-noising and local feature enhancement, especially in the estimation of the voltage flat zone of lithium batteries or electric vehicle batteries. Compared with the conventional technology, it is more high estimation accuracy.

In addition, the present invention also considers the characteristics of lithium iron batteries and introduces transfer learning methods to match multi-level neural networks. Apply a model pre-trained in one task to another related task to reduce training time and the need for data collection. In particular, applying the model pre-trained in the capacity estimation task of lithium batteries to other batteries of different types, brands, and capacities does not require a large amount of new data for retraining, so it can significantly save time and resources, make rapid estimations to improve accuracy and performance on new tasks.

Compared with conventional technology, the present invention has the following advantages:
1. Improving the shortcomings of the conventional battery state estimation model in inaccurately estimating within the voltage flat zone of the battery.
2. Quickly and accurately estimating batteries of different types, brands, and capacities, especially for electric vehicle batteries.

The foregoing descriptions of the preferred embodiments of the present invention have been provided for the purposes of illustration and explanations. It is not intended to be exclusive or to confine the invention to the precise form or to the disclosed exemplary embodiments. Accordingly, the foregoing descriptions should be regarded as illustrative rather than restrictive. Obviously, many modifications and variations will be apparent to professionals skilled in the art. The embodiments are chosen and described in order to best explain the principles of the invention and its best mode for practical applications, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary to confine the scope defined by the claims to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules on the requirement of an abstract for the purpose of conducting survey on patent documents, and should not be used to interpret or limit the scope or meaning of the claims. Any advantages and benefits described hereto may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A method for estimating state of batteries, comprising steps of:
providing a first-level neural network, a second-level neural network and a third-level neural network to form a multi-level neural network;
extracting features from a charging and discharging data of a battery to be estimated through the first-level neural network to form a first-stage output data, and transferring the first-stage output data to the second-level neural network;
enhancing local features in the first-stage output data through the second-level neural network to form a second-stage output data;
combining the first-stage output data with the second-stage output data to form a combination result; and
inputting the combination result into the third-level neural network for data modeling, to generate a state estimation result of the battery to be estimated.

2. The method of claim 1, wherein the charging and discharging data is a time series data including the features selecting from a group consisting of voltage, current, temperature and their combination.

3. The method of claim 1, wherein forming the combination result comprises a step of:
applying a positional encoding to the first-stage output data to combine with the second-stage output data.

4. The method of claim 1, wherein the first-level neural network includes a denoising autoencoder model, the second-level neural network includes a temporal convolution model, and the third-level neural network includes a attention model.

5. The method of claim 4, wherein forming the second-stage output data comprises steps of:
providing a dropout layer in the temporal convolution model;
performing a convolution operation to the first-stage output data through the temporal convolution model; and
combining feature data output from the dropout layer with the features in the first-stage output data that have not yet entered the temporal convolution model.

6. The method of claim 1, further comprising a training process, wherein the training process comprises a step of:
providing Gaussian noise for the first-level neural network.

7. The method of claim 6, wherein the training process comprises steps of:
providing a first training dataset collected from a first battery to train the multi-level neural network, so as to make the multi-level neural network suitable for estimating the state of the first battery;
provide a second training dataset collected from a second battery, and a data volume of the second training dataset is less than that of the first training dataset, wherein the second battery is employed as the battery to be estimated, and the second battery has at least one of type, brand and capacity different from the first battery;
using the second training dataset to train the multi-level neural network that has been previously trained with the first training dataset; and
employing the multi-level neural network trained by using the second training dataset to estimate the state of the battery to be estimated.

8. The method of claim 7, wherein the data volume of the second training dataset provided for the training process is reduced by 30% of that of the first training dataset.

9. The method of claim 7, wherein a range of electric current of the first training dataset is consistent or inconsistent with that of the second training dataset, and the method further comprises a step of:
providing an input data collected from the second battery for an estimation task thereof to be input the multi-level neural network, wherein a range of electric current of the input data is consistent with that of the second training dataset.

10. The method of claim 4, further comprising:
performing an estimation within a voltage flat zone of the battery to be estimated.

11. The method of claim 5, further comprising:
performing an estimation within a voltage flat zone of the battery to be estimated.

12. The method of claim 6, further comprising:
performing an estimation within a voltage flat zone of the battery to be estimated.

13. The method of claim 7, further comprising:
performing an estimation within a voltage flat zone of the battery to be estimated.

14. The method of claim 8, further comprising:
performing an estimation within a voltage flat zone of the battery to be estimated.

15. The method of claim 9, further comprising:
performing an estimation within a voltage flat zone of the battery to be estimated.
